(19) United States
(12) Patent Application Publication
(10) Pub. No.: US 2009/0241500 A1
(43) Pub. Date: Oct. 1, 2009

(54) RIDING MOWER ATTACHMENT

(76) Inventor: HOWARD T. PANKEY, Imboden, AR (US)

Correspondence Address: Alfred F. Hoyte, Esq.;Suite 500, 1101 30th Street, N.W., Washington, DC, 20005, US

(21) Appl. No.: 12/060,623

(22) Filed: Apr. 1, 2008

(51) Int. Cl. A01D 34/84

(52) U.S. Cl. 56/12.7

(57) ABSTRACT

An attachment for a lawnmower which allows simultaneous cutting and trimming operations. The attachment consists of a centrally located housing having a relatively massive main body, a central bore formed in the main body allows for placement of the attachment onto the drive shaft of the mower, the drive shaft coupled to a source of motive power such as a gas powered engine. A plurality of filament coupling areas are evenly spaced about the periphery of the main body of the attachment, each coupling area having a filament extending therefrom. The filaments are of a sufficient length to extend exteriorly of the lawn mower housing to effect trimming operations as the mower is operated in the fringe areas of the lawn.

### 1. BACKGROUND OF THE INVENTION

The present invention relates to rotary lawn mowers. More particularly, it relates to an attachment for a lawn mower which facilitates simultaneous mowing and trimming.

### STATEMENT OF THE PRIOR ART

A conventional mower includes a rotary blade attached to a motor driven shaft. The blade, which may be a regular mowing blade or a mulching blade is, for obvious safety reasons, sized to remain within the mower housing, which also includes the motor, wheels for rolling the mower over the lawn surface, and a handle portion extending therefrom which contains the controls and allows a user to roll the mower over the lawn surface. A problem with this arrangement is that fringe areas of the lawn cannot be accessed by the blade. These fringe areas must be trimmed with other tools such as a weed trimmer or mower, adding considerably to the time to complete the mowing job. In the case of a large yard, the additional time consumed by the fringe trimming operation is often considerable, as much as the mowing operation itself. Additionally, these trimmers are not low maintenance, requiring service more frequently than the mower itself as the trimming line must be constantly replaced. Gas powered trimmers require fuel and therefore add greatly to the overall pollution and energy consumption due to lawn maintenance operations. Several attempts have been made to alleviate this problem. U.S. Pat. No. 5,701,728 issued to Koka et al. discloses a lawn mower with a trimming assembly. The trimming assembly consists of a pair of trimming lines mounted directly to the mower blade. The lines extend radially from end portions of the blade. The drawback with this mechanism is that it requires modifications to the mower blade. Specifically, holes must be drilled in the blade in order to position the filament housing onto the blade. Also, the filament housing drastically alters the aerodynamics of the mower blade. Given the speed of rotation of the blade, this aerodynamic change could produce unforeseeable loading on the mower motor, drive shaft and coupling. Also, as the filament housing is proximate end portions of the blade, it is subject to being dislodged or displaced during the mowing operation, especially if tall grass or debris are encountered. Finally, placement of the filament housing at the end portions of the blade results in a higher rotational speed thereof which also increases the possibility of damage to the filament housing or unintended disconnection of the filament from the housing upon impact with debris. U.S. Pat. No. 4,374,465 issued to Comer discloses another trimming line attachment for a mower. The drawbacks with this assembly are the same as for the Koka patent as discussed above. An additional problem with the Comer device is that the attachment means for the filament is actually located on the bottom surface of the blade, where it is highly likely to come into contact with debris such as rocks and cans which could easily dislodge the whole assembly.

U.S. Pat. No. 4,819,416 issued to Jones discloses an alternate cutting member using filaments which are intended to replace, not supplement, a traditional mower blade.

None of the above inventions and patents, taken either singly or in combination, is seen to describe the instant invention, as claimed.

### SUMMARY OF THE INVENTION

The present invention overcomes the disadvantages of the prior art by providing an attachment for a lawnmower which allows simultaneous cutting and trimming operations. The attachment consists of a centrally located housing having a relatively massive main body. A central bore formed in the main body allows for placement of the attachment onto the drive shaft of the mower, the drive shaft coupled to a source of motive power such as a gas powered engine. A plurality of filament coupling areas are evenly spaced about the periphery of the main body of the attachment, each coupling area having a filament extending therefrom. The filaments are of a sufficient length to extend exteriorly of the lawn mower housing to effect trimming operations as the mower is operated in the fringe areas of the lawn.

Accordingly, it is an object of the invention to provide an improved lawn mower attachment which facilitates trimming fringe portions of the lawn.

It is another object of the invention to provide a lawn mower attachment which uses filaments actuated by the lawn mower engine.

It is another object of the invention to provide a lawn in mower attachment having a relatively massive main body to which a plurality of filaments are attached.

It is another object of the invention to provide a lawn mower attachment which is connected to the engine output shaft by a single coupling.

It is another object of the invention to provide a lawn mower attachment which has minimal interference with the lawn mower blade aerodynamics.

It is another object of the invention to provide a lawn mower attachment which is attached proximate the axis of rotation of the drive shaft to reduce the speed of rotation thereof.

Finally, it is a general object of the invention to provide improved elements and arrangements thereof in an apparatus for the purposes described which is inexpensive dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar pans parts throughout the several views, and wherein:

FIG. 1. shows a perspective plan view of the underside of an exemplary lawn mower employing the attachment of the present invention.

FIG. 2 shows a perspective view of the lowermost surface of the attachment when installed on the lawn mower.

FIG. 3 shows a perspective view of the lowermost surface of an alternative embodiment of the attachment when installed on the lawn mower.

### DETAILED DESCRIPTION

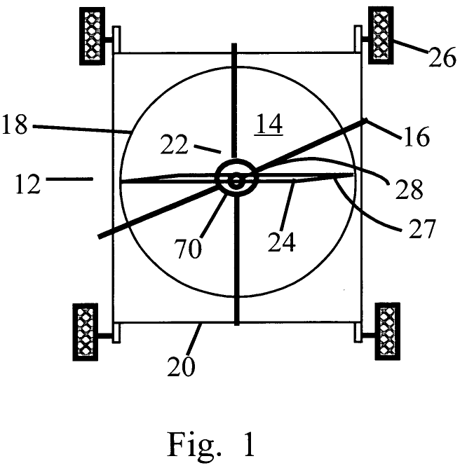

Referring now to FIGS. 1-3, the attachment of the present invention, generally indicated by the numeral 10, is shown. The attachment 10 is primarily designed for use with riding mowers, but may be used with regular push mowers as is depicted in FIG. 1.

When used with a riding mower, the relatively robust construction of the attachment allows it to withstand many high impact collisions with rocks, bricks, and other debris. It can be readily appreciated by those familiar with landscaping and general lawn maintenance that this type of debris, often encountered when operating mowers in general, poses an even greater risk of damage when encountered by a riding mower as the operator's view of the ground is shielded by the relatively large housing of the mower. Also, as riding mowers are typically used on much larger lawn areas than push mowers, it can be painstaking if not outright impractical to check the entire lawn for debris. Additionally, the size of lots on which riding mowers are used makes the job of trimming the fringe areas that much more arduous.

A rotary mower according to this invention is shown as 12 in FIG. 1. Mower 12 includes a generally circular housing 14 having a top deck 16 and a circumferentially extending side wall 18 that depends downwardly from deck 16. Side wall 18 terminates in a lower edge 20. Together top deck 16 and side wall 18 define a substantially enclosed cutting chamber 22 that encloses a rigid cutting blade 24 made from a suitable metallic material such as steel.

The housing 14 is supported at a selected height above the ground by any suitable means, such as a plurality of wheels 26. However, a ground effect air cushion support means or other means may also be utilized. Blade 24 has one or more sharpened cutting edges 27, and is attached by a blade retainer 28 to a power source (not shown) which may be any suitable means for rotating blade 24 at a speed sufficient to sever standing vegetation. The power source may be an internal combustion engine, or an electric motor, mounted on deck 16. When blade 24 is so attached to the power source, the plane of the blade is above the lower edge 20 of side wall 18 for safety. The thickness of the main body 34 of the attachment 10 is selected to ensure that a cutting plane created thereby extends below lower edge 20 to trim areas outside of the mower housing 14 as will be explained in more detail later.

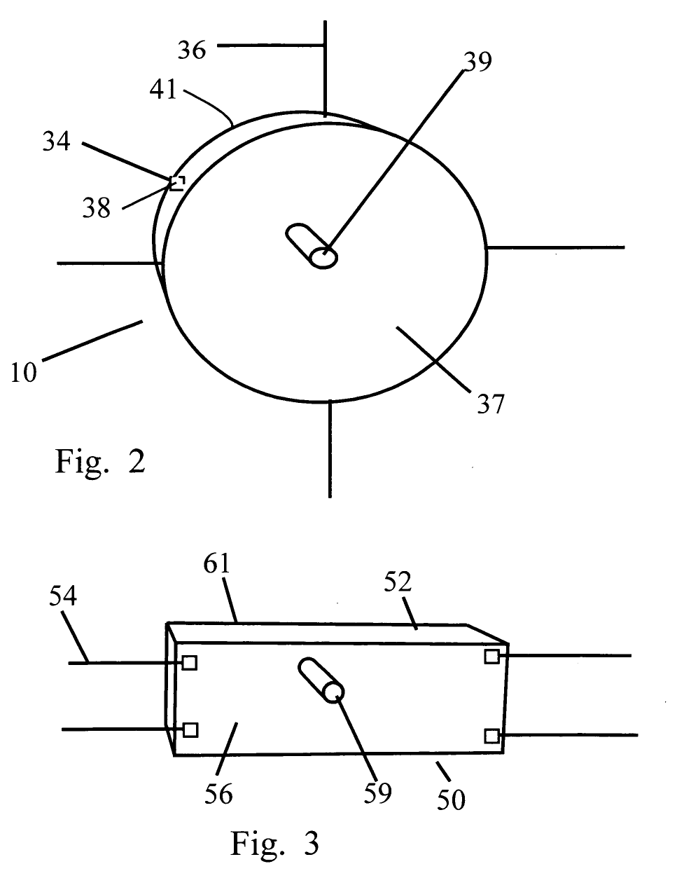

As has been previously mentioned the attachment has a main body 34 which is relatively massive with respect to the size of the filament or cable used with. the invention. Referring particularly to FIG. 2, the attachment main body 34 may be made of any suitable sturdy material such as steel or other metal. A high strength plastic or other high strength, non-metallic material may be used to form the main body 34 of the attachment 1.0 10. The main body 34 is substantially disc shaped and has a thickness sufficient to ensure that the plane of rotation of filament or cable 36 extends below the mower housing 12, but not so far below the housing 12 so that the cable 36 trims standing vegetation substantially lower than the mower blade. It can be appreciated that the cable 36 would quickly wear out if its plane of rotation were substantially lower than the plane of rotation of the mower blade 24, as most of the vegetation would be severed by the cable 36 and not the mower blade 24. The filaments or cables 36 are connected at regularly spaced attachment points about the edge portion of the lowermost surface 37 of the attachment main body 34. The uppermost surface 41 faces the interior surface of the mower deck, the spacing between the uppermost surface 41 and the lowermost surface 37 being such that the plane of rotation of the cables 36 is lower than the lower edge 20 of sidewall 18. While a standard line trimming filament may be employed, a wire cable having high durability is preferable. Cable clamps 38 or other suitable coupling means are used to hold the cables 36 in position. Centrally located bore 39 extends completely through attachment 10 and is sized to allow placement of the power output shaft 70 of the mower engine therethrough. Preferably, the dimensions of the inner surface of the bore 39 are such that some frictional engagement with the shaft occurs to help prevent slippage between the shaft 70 and the attachment 10.

An alternative configuration for an attachment, generally indicated by the numeral 50 is shown in FIG. 3. This embodiment utilizes a substantially rectangular elongated main body 52. Cables 54 are attached proximate corner portions of the lower surface 56 of the main body 52. The elongated shape of the main body 52, in combination with the cables 54 extending from the corner positions of the main body 52 causes rotation of the cables 54 in closely spaced pairs, more closely approximating the cutting action of a mower blade. As with attachment 10 a central bore 59 extends through the main body 52 and the spacing between lowermost surface 56 and uppermost surface 61 establishes a plane of rotation, below the lower edge 20 of the sidewall 18 of the mower deck. This arrangement is more effective against relatively thick standing vegetation.

Installation of the attachments 10, 50 is accomplished by first removing the retainer 28 which may be a threaded nut and washer threadedly engaged with the end of output shaft 70. The attachment 10, 50 is then put in position, with the motor output shaft 70 extending through central bore 39, 59. The attachment 50 will abut a stop (not shown) in the shaft 70. Retainer 28 is then replaced and sufficiently tightened to ensure co-rotation of the shaft 70, blade 24, and attachment 10, 59. The plane of rotation of the cables 36, 54 may then be visually determined. The cables 36, 54 may be extended manually so that the plane of rotation may be observed. However, a flat elongated surface such as a yardstick, or preferably a level may be used. Utilizing this method the yardstick (not shown) or level (not shown.) is placed flush against the lowermost surfaces 37, 56 of the main body of attachments 10, 50 and extended out past sidewall 18. Visual inspection of the yardstick or level will enable a rapid determination of whether the cables 36, 54 will extend exteriorly of the sidewall, when rotated at high speed. If it is determined that the plane of rotation does not extend below the lower edge 20 of the sidewall 18 then a spacer may be used to adjust the plane of rotation of the cables 36, 54.

In accordance with one embodiment of the invention, the spacer may be an attachment main body 34, 52. Of course the cables 36, 54 must be detached from the attachment 10, 50 if it is to be used as a spacer. Preferably, a used attachment 10 is employed as a spacer.

From the foregoing description, one skilled in the art can easily ascertain the essential characteristics of this invention and, without departing from the spirit and scope thereof, can. make various changes and modifications of the invention to adapt it to various usages and conditions.

It is to be understood that the present invention is not limited to the sole embodiment described above, but encompasses any and all embodiments within the scope of the following claims:

1. An attachment for a rotary lawn mower, said mower having a housing, a drive shaft coupled to a source of motive power, and a blade coupled to said drive shaft by a retaining member, said attachment comprising:
a substantially planar main body having an uppermost and a lowermost surface spaced a predetermined distance apart and having a bore formed therein, said bore sized to allow placement of said drive shaft into and through said main body, said predetermined distance sufficient to position said lowermost surface below said housing;
at least two opposing pairs of filaments connected to and extending from edge portions of said lowermost surface;
whereby placement of said main body of said attachment about said drive shaft between said blade and said retaining member causes extension of said filaments in a plane of rotation exteriorly of said housing when said blade is rotated at a sufficient speed to cause cutting of standing vegetation.

2. The attachment of claim 1 wherein said attachment is substantially disc shaped.

3. The attachment of claim 1 wherein said attachment is substantially rectangular.

4. The attachment of claim 3 wherein said filaments are attached at each of four corner portions of the attachment, so that pairs of said filaments extend in closely spaced, substantially parallel relation.

5. The attachment of claim 1 wherein said plane of rotation of said filaments extends below said mower housing, and said attachment has a predetermined thickness, the extent to which said plane of rotation extends below the mower housing is a function of said predetermined thickness.
